(19) United States
(12) Patent Application Publication
(10) Pub. No.: US 2003/0128630 A1
(43) Pub. Date: Jul. 10, 2003

(54) Parking meter

(76) Inventors: Agenor Krygler, Warschau (PL); Alicja Krygler, Warschau (PL)

Correspondence Address: FRIEDRICH KUEFFNER, SUITE 910, 317 MADISON AVENUE, NEW YORK, NY, 10017, US

(21) Appl. No.: 10/163,074

(22) Filed: Jun. 4, 2002

(30) Foreign Application Priority Data
Jan. 4, 2002 (PL) P-351531

(51) Int. Cl. G04F 1/00; G04F 3/00

(52) U.S. Cl. 368/90

(57) ABSTRACT

This invention relates to a parking meter (100, 200) with an input device (34) for paying means and at least one indicating device (20) for indicating the expiration of a paid parking time, the indicating device (20) having at least one optical indicating means respectively for a corresponding number of parking spaces, respectively one actuating means (18) with an indicating means (20) being allocated to each respective parking space, whereby furthermore all indicating means (20), the actuating means (18) and the input device (34) for payment means are connected with a common control device (32), whereby furthermore a signalling device (38) is provided for signalling the paid parking time and the input device (34) for payment means is configured as a chip card actuating device (30, 34). Here, the indicating means (20) allocated to each actuating means (18) is constituted in such a way that this indicating means indicates at least three different conditions which can be read by a checking person, whereby a first condition signalizes to the checking person “paid parking time running”, a second condition “paid parking time expired” and a third condition “paid parking time expired for longer than a predetermined time”.

For such a parking meter (100, 200), a battery saving operation is made possible by the fact that the signalling device (38) comprises an acoustic signal transmitter and/or a display.

### BACKGROUNG OF THE INVENTION

This invention relates to a battery-operated parking meter according to the preamble of claim 1.

Especially in town centers with dense traffic, the available parking space is often limited. In order to counter long-term parking, according to the state of the art so-called parking meters are used which have a coin insertion slot into which different coins can be inserted, depending on the desired parking time and the necessary parking fees. By actuating a turning knob existing on the parking meter, the parking meter relases the selected and paid parking time. A rotating plate, which is connected with a clock, rotates after expiration of the parking time back to a “0-mark” which indicates the expiration of the paid parking time. The disadvantage of these parking meters consists in the quite complicated mechanism required which, in addition to this, is susceptible to wear. Even if such parking meters are configured as double parking meters for two parking spaces, finally a corresponding time synchronously running mechanism is respectively required per parking space.

In many towns and municipalities, besides parking meters parking ticket issuing machines are also used which, after insertion of a certain amount of money and selection of the desired parking time, activate a printing unit which outputs the parking time resulting from the paid fees as final parking time. With this system, the parking space user is instructed to place the issued parking ticket inside the motor vehicle so as to be visible to allow to check if the parking time is exceeded. This method is quite troublesome not only for the parking space user since he has to cover the way there as well as the way back from the vehicle to the parking ticket issuing machine before he can lock the vehicle and leave the parking space. Add to this that, when being placed into the vehicle, the parking tickets are blown away from the instrument panel, where they always have to be placed, by external blast or already by slamming the door, and lay on the floor of the vehicle, unrecognizable for a check. The parking ticket issuing machines are also expensive since they must comprise an electrically driven printing unit.

Furthermore, it is known from the German utility model 296 06 229 to provide an additional housing with window for the insertion of a parking ticket on a parking ticket machine for each parking space.

For avoiding receipts concerning the paid parking time which must be placed in the vehicle so as to be visible, from WO 98/07123 we know a parking meter with an input device for means of payment and with an indicating device for indicating the expiration of a paid parking time. Here, the indicating device has at least one visual or acoustic indicating means for a corresponding number of parking spaces, whereby an actuating means is operationally connected with the indicated means assigned to it, whereby furthermore all indicating means, the actuating means and the input device for means of payment are connected with a common control device. A sound reproduction device with an acoustic announcement concerning the paid parking time is provided for. The indicating means are configured as visual devices, for example in form of luminescent diodes, or as acoustic devices, whereby an indicating means is assigned to each actuating means. The input device for means of payment is configured as a coin actuating device and/or as a chip card actuating device.

Furthermore, a generic parking meter is known from the previous application EP-B1-1 038 273. The prior art explained and commentated in this printed document is explicitly referred to herewith.

The parking meter of EP-B1-1 038 723 is an autonomous device which can work over a longer period without any intervention of a checking person since neither a coin collecting container must be emptied, nor a parking ticket printer must be refilled with printing paper. There result considerable cost savings with respect to operation and maintenance. Principally, it would be conceivable to provide this parking meter with a net supply for the electronics fitted in its inner space. However, this would make the laying of cables necessary and thus cause considerable installation costs and a reduction of the flexibility for the erection of the parking meter. Therefore, it is desirable that such an autonomous battery is operated not only with a built-in battery but that the built-in battery also achieves a lifetime as long as possible due to a current consumption of the parking meter reduced to a minimum in order to keep the maintenance intervals and thus the maintenance costs as low as possible.

It appeared in practice that, for the parking meter known from EP-B1-1 038 273, an essential part of the current consumption is caused by the sound reproduction device which emits acoustic announcements to the user of the parking meter over a loudspeaker.

### SUMMARY OF THE INVENTION

Thus, the aim of this invention is to make available an improved parking meter of the above mentioned type which eliminates the above mentioned disadvantages and which is characterized by a clearly extended lifetime of the built-in battery for a simultaneously simple operation and reading by a checking person.

This aim is achieved by a parking meter of the above mentioned type with the characteristics indicated in claim 1.

According to the invention, it is provided for that the signalling devices for reducing the energy consumption of the parking meter comprises an acoustic signal transmitter controlled by the control device and/or a display controlled by the control device. By acoustic signal transmitter, we understand here—contrary to a loudspeaker—a buzzer as it is used for example in mobile telephones or in other compact electronic devices which emits a good audible buzzer tone or beep by being minaturized and having an extremely low current consumption. The display is correspondingly a LCD display or a comparable display with a very low current consumption and a good reading under everyday conditions. By means of the acoustic signal transmitter or display, it is possible with an extremely low expenditure of energy to make available the necessary announcements for the user of the parking meter.

Preferable further improvements of the device are described in the claims 2 to 16.

For a simple operability of the parking meter by a driver of a parking space assigned to a parking meter, the control device is designed so that, at each insertion of a chip card into the chip card actuating device, it debits the chip card with a predetermined unit and correspondingly adds up the units. In particular, the control device is configured in such a way that the debit of the unit from the chip card is confirmed by a signal of the acoustic signal transmitter and/or of the display. The predetermined unit corresponds, for example, to a parking time of 30 minutes.

To define a maximal parking time duration, the control device works in such a way that, after a predetermined number of chip card insertions, no further debit with a predetermined unit ensues or that the chip card actuating device is locked for further insertions of the chip card.

In a preferred embodiment, the indicating means comprises at least one luminescent diode which represents the three states by means of at least one, however preferably two, however also three luminescent diodes with different luminous colours and/or by means of differently intermittent or constant lighting up. For example one luminescent diode is provided for, whereby an intermittent lighting up with a first predetermined frequency or with a first predetermined interval pattern signalizes the first state, an intermittent lighting up with a second predetermined frequency or a second predetermined interval pattern signalizes the second state and eventually an intermittent lighting up with a third predetermined frequency or a third predetermined interval pattern signalizes the third state, whereby especially one of the predetermined frequencies is infinite and corresponds to a continuous lighting up.

Preferably, two luminescent diodes with a different colour are provided for, whereby a lighting up of the luminescent diode with a first colour, for example green, signalizes the first state, a lighting up of the other luminescent diode with a second colour, for example red, signalizes the second state and the third state by alternating flashing of both luminescent diodes with a predetermined frequency or with a predetermined interval pattern.

In a further embodiment, three luminescent diodes with different colours are provided for, whereby a luminescent diode with the colour green signalizes the first state, a luminescent diode with the colour red the second state and a luminescent diode with the colour yellow the third state by permanent light, i.e. by continuous lighting up and/or intermittent lighting.

The extinguishing of the lighting or flashing luminescent diodes can also be used as a signal for the expiration of the parking time.

For example, the “predetermined time” of the third state amounts to one hour so that, from one hour after expiration of the paid parking time on, the removal of the vehicle, which now occupies a parking space without being authorized to, can begin.

For a simple and clear operability by a driver and a simple and clear reading by a checking person without having to provide the parking spaces themselves, for example on the ground, with additional markings, the parking meter has a layout of the parking spaces assigned to this parking meter, whereby the actuating means and the indicating devices are arranged or indicated in the layout in such a way that an actuating means and an indicating device are assigned to each parking space of the layout in an unmistakable way. Hereby, the allocation of the parking spaces indicated in the layout to real parking spaces results from the representation which is different with respect to the scale but coinciding with respect to the geometry between the layout and the real parking space arrangement. Therefore, additional markings to assign to are not necessary.

A simple assignment of actuating elements and indicating devices on the parking meter to corresponding parking spaces on the layout is obtained by the fact that a symbol, especially a numeral, is assigned to each parking space in the layout on the parking meter, whereby the same symbol, especially the same numeral, is assigned to each actuating means and to each indicating device, as well as to the corresponding parking space.

### BRIEF DESCRIPTION OF THE DRAWINGS

The invention will be explained in detail below with reference to the attached drawings.

FIG. 1 is a graphical view of a preferred embodiment of a parking meter.

FIG. 2 is a schematic block diagram of a parking meter assembly according to FIG. 1.

FIG. 3 shows the representation of a parking meter according to the invention which is in action.

FIG. 4 shows the front plate of the parking meter according to FIG. 3.

FIG. 5 shows the block diagramm of a parking meter according to the invention with an acoustic signal transmitter (buzzer) as a signalling device.

FIG. 6 shows the block diagramm of a parking meter according to the invention with an acoustic signal transmitter (buzzer) and a display as a signalling device.

### DESCRIPTION OF THE PREFERRED EMBODIMENTS

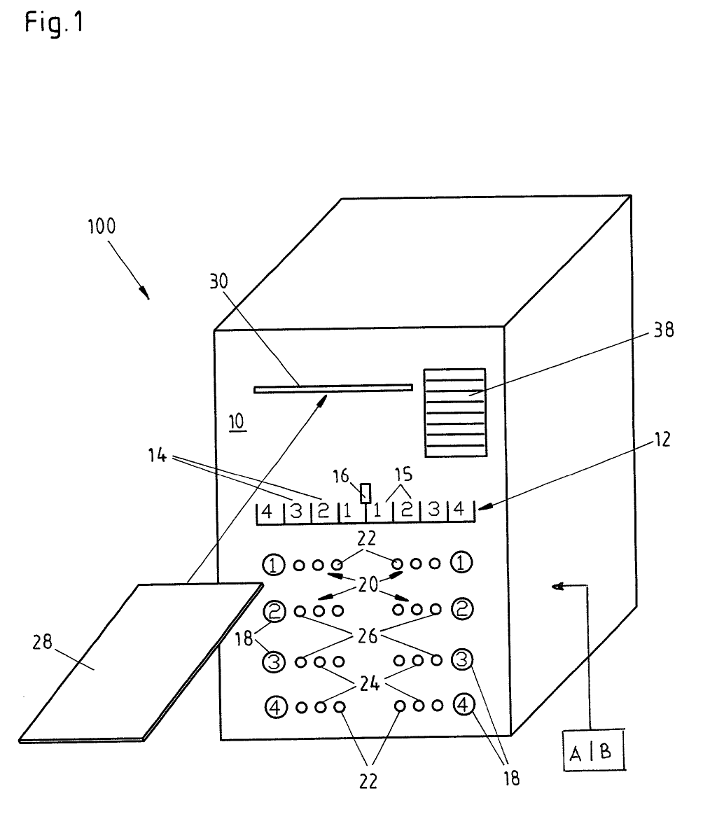

The preferred embodiment of a parking meter according to the invention 100 represented in FIG. 1 comprises a front plate 10 on which a layout 12 of parking spaces assigned to this parking meter 100 is placed. Each parking space 14 of the layout 12 is provided with a numeral, whereby a symbol 16 illustrates the location of the parking meter 100 in the layout. The parking spaces 14 or 15 which are on the right and on the left of the parking meter according to the invention 100 are numbered consecutively respectively with the numerals “1” to “4”. A respective actuating means 18 and a respective indicating device 20 is clearly assigned to each parking space 14, 15 for respectively the parking spaces 15 on the right of the parking meter 100 and the parking spaces 14 on the left of the parking meter 100 by means of the corresponding numerals “1” to “4”. The number of parking spaces 14, 15 on the left and on the right of the parking meter according to the invention 100 can be selected at will and is here, for example, only respectively four.

Each of the indicating devices 20 comprises, according to a first embodiment, two luminescent diodes 24, 26, whereby the respective first luminescent diode 26 lights up with green colour as a confirmation for the fact that the parking time is paid, when the second luminescent diode 24 lights up with red colour, it indicates that the paid parking time is expired. After expiration of this first red time phase, for a predetermined further time phase, red flashing light is emitted as an indication for the checking person that the parking time is expired for a long time so that, with this last time phase, the checking person is requested to arrange for the car to be towed away because of exceeding the parking time.

For a further embodiment, each of the indicating devices 20 contains three luminescent diodes 22, 24 and 26, whereby a respective first luminescent diode 22 lights up with yellow colour, a respective second luminescent diode 24 with red colour and a respective third luminescent diode 26 with green colour. Like also in the case of the first embodiment with two luminescent diodes, an inserting slot 30 is provided for the insertion operation of a chip card. Signals for a parking space user ensue over a signalling device 38 with a low current consumption, namely an acoustic signal transmitter or buzzer and/or a display, in the way described hereunder.

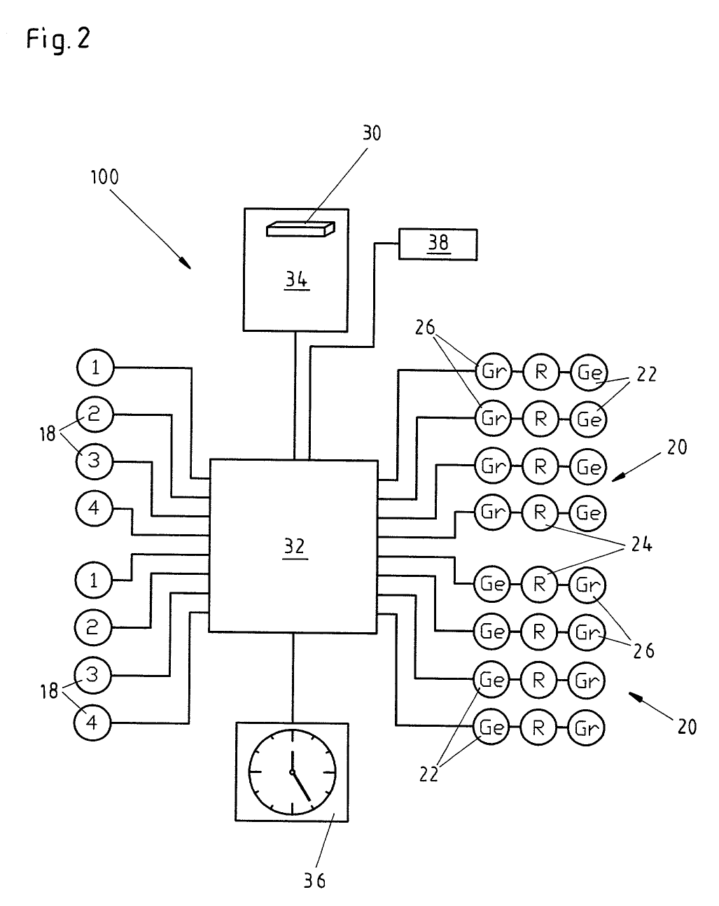

FIG. 2 shows a schematic block diagram of the parking meter of FIG. 1 for an embodiment with three luminescent diodes, whereby the same parts are indicated by the same reference numerals so that reference is made to the description above of FIG. 1 for their explanation. The block diagram for an embodiment with two luminescent diodes is configured in the same way. Only the function of the first luminescent diode 22 with yellow colour light is integrated into the luminescent diode 24 with the red colour light, namely so that, in a first controlled time phase, the diode 24 emits red permanent light and, in a second controlled time phase, red flashing light. The yellow luminescent diodes 22 are additionally characterized with “Ge”, the red luminescent diodes 24 are additionally characterized with “R” and the green luminescent diodes 26 are additionally characterized with “Gr”. The luminescent diodes 22, 24, 26 of the indicating means 20 and the actuating means 18 are connected with a control device 32 which records actuations of the actuating means 18 and which triggers time controlled the luminescent diodes 22, 24, 26 of the indicating devices 20 in the way described in detail below.

Moreover, a chip card actuating device 34 with an insertion slot 30, a signalling device 38 and a clock module 36 are connected with the control device 32. The clock module 18 serves as a timer for the control device 32 which triggers time controlled the luminescent diodes 22, 24, 26 of the indicating devices 20 and, eventually, the signalling device 38. The control device 32 is, for example, a microprocessor unit and is preferably connected with the other components 18, 20, 34, 36 and 38 over a data bus.

The parking meter 100 is operated, for example, by means of cheque cards or other chip cards, similarly to telephone cards, whereby the chip cards, for example, can be bought as parking cards in service stations or in kiosks. A chip or parking card contains, for example, 500 units, whereby one unit corresponds to a predetermined parking time of, for example, 30 minutes.

An example of an actuation course of the parking meter 100 and of a reading by a checking person for an embodiment with three luminescent diodes 22, 24, 26 will be described below.

The parking card 28 with, for example, 500 parking units is inserted into the insertion slot 30. By this first insertion, the parking card 28 is debited with one unit for a parking time of ½hour by the control device 32 and the card is withdrawn or output again. If a longer parking time is desired, the card will be inserted again, a further unit is debited by the control device 32 and the card is withdrawn or output again, whereby the parking time is summed up to 1 hour, 1 ½ hour, 2 hours etc., depending on the number of insertions or inputs of the parking or chip card. Appropriately, a maximal parking time of, for example, two hours, is predetermined so that the control device 32 does not debit any more unit after four insertions or locks the insertion slot 30 of the chip card actuating device 34.

Whenever the chip card 28 is debited wih one parking unit, the control device 32 controls for example the acoustic signal transmitter (buzzer) inside the signalling device 38 in such a way that this signal transmitter emits a buzzer tone. If several units are debited the one after the other and added up subsequently and if the added units are assigned to a parking space by pushing the actuating means 18, the acoustic signal transmitter emits a number of sounds which corresponds to the number of added units. In this way, the payment procedure essential range can be transmitted to the user of the parking meter in an extremely cost saving manner. An existing display can also be used in the same way.

The number of actuating means 18 corresponds to the number of parking spaces 14, 15 assigned to the parking meter 100. For the parking space “3” of the real parking spaces 15 arranged on the right of the parking meter 100, for example, the actuating means “3” of the right row of the actuating means 18 is to be pushed (see FIG. 1). The procedure for an embodiment with two luminescent diodes 24, 26 is the same as described above.Thereupon, the control device 32 triggers the indicating device 20 with the luminescent diodes 22, 24 and 26 or with the luminescent diodes 24, 26 assigned to this parking space so that the green luminescent diode 26 always lights up until expiration of the paid parking time. After expiration of the paid parking time, thus for example after one hour, the green luminescent diode 26 is extinguished and the control device 32 lets the red luminescent diode 24 light up. This signalizes to a checking person who supervises a correct paying of the parking space utilization that the paid parking time for this parking space is expired. After a further predetermined time of, for example one more hour, the control device 32 lets flash the red luminescent diode 24 for an embodiment with two luminescent diodes 24, 26 and lets the yellow luminescent diode 22 continuously light on or flash for the embodiment with three luminescent diodes 22, 24, 26. This signalizes to the checking person that the paid parking time is exceeded by more than the predetermined time, thus here by more than one hour, as far as the vehicle of the parking space user still is on this parking space. In this case, the checking person can order a removal of the vehicle which is now unauthorizedly parking, for example by driveaway-towaway.

To sum up, a lighting up of the green luminescent diode 26 thus signalizes that the paid parking time is still running, a lighting up of the red luminescent diode 24 that the parking time is expired and that a period of grace of, for example, one hour is running and a lighting up of the yellow luminescent diode 22 or a flashing of the red luminescent diode 24 that the parking time is exceeded by more than the period of grace of, for example, one hour and that the vehicle which is parked on the corresponding parking space 14, 15 is to be towed away. Herewith three different states are indicated time controlled.

In the alternative embodiment, only two luminescent diodes of different colour, for example only the red luminescent diode 24 and the green luminescent diode 26, are provided for. During the parking time, the green luminescent diode 26 lights up continuously, during the period of grace the red luminescent diode flashes and, after expiration of the period of grace, the red luminescent diode 24 lights up continuously or an inversed flashing sequence of permanent light and flashing light is also possible. This is alternatively performed with only one luminescent diode which can light up green as well as red dependently on the tension respectively applied.

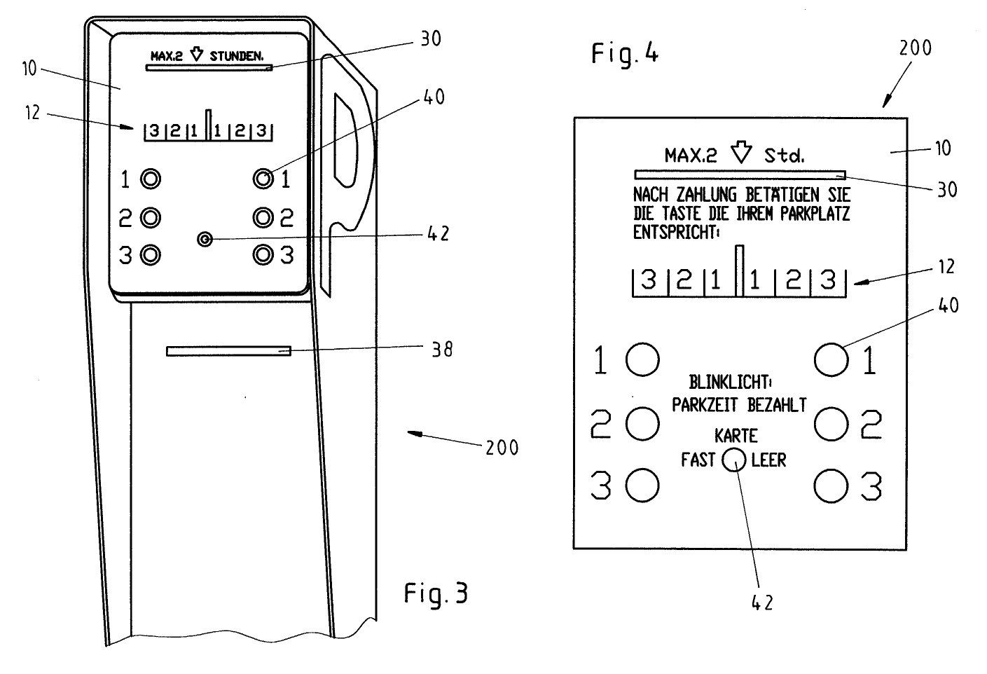

For an embodiment with only one single luminescent diode, as represented in FIGS. 3 and 4, all permanent light and flashlight stages are combined in one luminescent diode which is a part of an actuating means 40 with an integrated luminescent diode. During the running time of the parking duration, this luminescent diode then emits green light. If the parking time is expired, red flashlight is emitted by the same luminescent diode. If the flashlight period is expired, a short period, for example of 15 minutes, can follow with red permanent light. The control of the individual light and time periods is also performed by the control device 32.

The light emitted by the luminescent diodes can be emitted in the form of flashlight, which is more economical and battery saving, or of permanent light or alternatively of flashlight and permanent light. It is essential that the running parking time, the expired parking time and an additional time are visually indicated so that the different states can be recognized by the parking space user as well as by the checking person.

In FIG. 3, a cutout of a parking meter 200 according to the invention is represented as it is conceived for the use in the practice. The input and output systems and the electronics of the parking meter 200 are placed on the upper end of a column. They comprise (see also FIG. 4)—as already described above—a front plate 10 with an insertion slot 30 for the chip card, a layout 12 of the parking spaces as well as actuating means 40 with an integrated luminescent diode which are assigned to the different parking spaces. The actuating means 40 can comprise mechanically acting microswitches which are directly mounted (together with the integrated luminescent diodes) on a printed card mounted behind the front plate 10. Sensors can also be used instead of mechanical means. With the integrated one luminescent diode per parking space, all time stages of a parking operation can be displayed in an energy saving way in the above described manner. Slot type openings for a signalling device 38 in form of an acoustic signal transmitter (buzzer) are placed below the front plate 10.

A further luminescent diode 42 can additionally be placed in the middle between two rows of actuating means 40, this diode indicating to the user of the parking meter that he has only a few units (for example three) on his chip card and that he must care about the buying of a new chip card or of an eventual recharging of the card. A second additional luminescent diode (not represented in FIGS. 3 and 4) can be provided for in order to indicate the early end of the battery capacity. In both cases, for energy saving reasons, it is advantageous if the indications by these luminescent diodes are not made with permanent light but with flashing light.

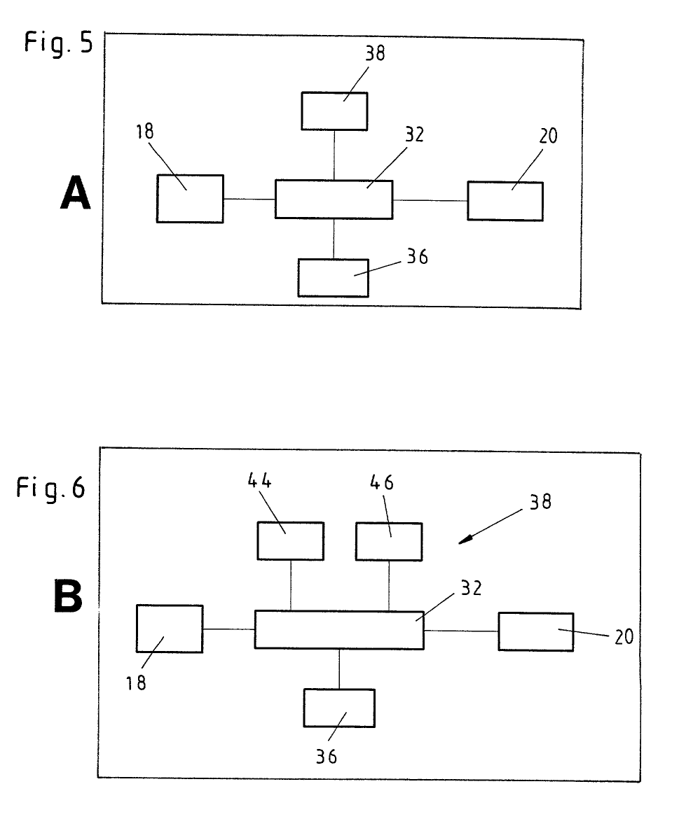

As already mentioned above, the battery saving indication of the debit of the parking units from the chip card 28 in the signalling device 38 can be realized by means of an acoustic signal transmitter (buzzer) and/or of a display. The corresponding block diagramm for the possible configurations is represented in FIGS. 5 and 6, whereby with reference to FIG. 2 the same parts are indicated with the same reference numerals. For the embodiment according to FIG. 5, the actuating means 18, the indicating device 20, the clock module 36 and a signalling device 38, which can be an acoustic signal transmitter or a display, can be connected with the central control device 32 (for example a microprocessor). In FIG. 6, an acoustic signal transmitter 44 as well as a display 46 are connected with the control device 32 inside the signalling device 38.

List of the reference numerals:

| | |
|---|---|
| 100, 200 | Parking meter |
| 10 | Front plate |
| 12 | Layout |
| 14, 15 | Parking space |
| 16 | Symbol |
| 18 | Actuating means |
| 20 | Indicating device |
| 22, 24, 26 | Luminescent diode |
| 28 | Chip card |
| 30 | Insertion slot |
| 32 | Control device |
| 34 | Chip card actuating device |
| 36 | Clock module |
| 38 | Signalling device |
| 40 | Actuating means with integrated luminescent |
| | diode |
| 42 | Luminescent diode |
| 44 | Acoustic signal transmitter |
| 46 | Display |

1. A battery-operated parking meter (100, 200) with an input device (34) for paying means and at least one indicating device (20) for indicating the expiration of a paid parking time, the indicating device (20) having at least one optical indicating means respectively for a corresponding number of parking spaces, respectively one actuating means (18) with an indicating means (20) being allocated to each respective parking space, whereby furthermore all indicating means (20), the actuating means (18) and the input device (34) for payment means are connected with a common control device (32), whereby furthermore a signalling device (38) is provided for signalling the paid parking time and the input device (34) for payment means is configured as a chip card actuating device (30, 34) designed for the insertion of chip cards (28) and whereby the indicating means (20) allocated to each actuating means (18) is constituted in such a way that this indicating means indicates at least three different conditions which can be read by a checking person, whereby a first condition signalizes to the checking person “paid parking time running”, a second condition “paid parking time expired” and a third condition “paid parking time expired for longer than a predetermined time”,
characterized in
that the signalling device (38) for reducing the energy consumption of the parking meter (100, 200) comprises an acoustic signal transmitter (44) triggered by the control device (32) and/or a display (46) triggered by the control device (32).

2. A parking meter (100, 200) according to claim 1,
characterized in
that the control device (32) is configured in such a way that, at each insertion of a chip card (28) into the chip card actuating device (30, 34), its debits a predetermined unit from the chip card (28) and correspondingly adds up.

3. A parking meter (100, 200) according to claim 2,
characterized in
that the control device (32) is configured in such a way that the debit of the unit from the chip card (28) is confirmed by a signal of the acoustic signal transmitter (44) and/or of the display (46).

4. A parking meter (100, 200) according to claim 2 or 3,
characterized in
that the predetermined unit corresponds to a parking time of 30 minutes.

5. A parking meter (100, 200) according to the claims 2 to 4,
characterized in
that the control device (32) is configured in such a way that, after a predetermined number of insertions of the chip card (28), no further debit with a predetermined unit ensues or that the chip card actuating device (30, 34) is locked for further insertions of the chip card (28).

6. A parking meter (100, 200) according to any of the claims 2 to 5,
characterized in
that the control device (32) is configured in such a way that, after actuation of an actuating means (18), it allocates a parking time preliminarly added on the base of insertion operations of the chip card (28) to the parking space (14, 15) assigned to this actuating means (18) and triggers the indicating device (20) assigned to this actuating means (18) time controlled correspondingly to the assigned parking time and that the number of defaced units is confirmed by a signal of the acoustic signal transmitter (44) and/or of the display (46).

7. A parking meter (100, 200) according to any of the preceding claims,
characterized in
that the indicating device (20) comprises at least one luminescent diode (22, 24, 26).

8. A parking meter (100, 200) according to claim 7,
characterized in
a luminescent diode (22, 24, 26) is provided for which indicates the three conditions by means of at least two, in particular three, different luminous colours and/or by means of differently intermittent or constant lighting up.

9. A parking meter (100, 200) according to claim 7 or 8,
characterized in
that a luminescent diode (22, 24, 26) is provided for, whereby an intermittent lighting up with a first predetermined frequency or with a first predetermined interval pattern indicates the first condition, an intermittent lighting up with a second predetermined frequency or with a second predetermined interval pattern indicates the second condition and an intermittent lighting up with a third predetermined frequency or a third predetermined interval pattern indicates the third condition.

10. A parking meter (100, 200) according to claim 9,
characterized in
that one of the predetermined frequencies is infinite and corresponds to a continuous lighting up.

11. A parking meter (100, 200) according to claim 7 or 8,
characterized in
that two luminescent diodes (22, 24, 26) of different colours are provided for, a continuous lighting up of the luminescent diode with a first colour indicating the first condition, a continuous lighting up of the other luminescent diode with a second colour the second condition or the third condition and an intermittent lighting up of one of the two luminescent diodes with a predetermined frequency or with a predetermined interval pattern the third condition or the second condition.

12. A parking meter (100, 200) according to claim 7 or 8,
characterized in
that three luminescent diodes (22, 24, 26) with different colours are provided for, a luminescent diode (26) with green colour indicating the first condition, a luminescent diode (24) with red colour the second condition and a luminescent diode (22) with yellow colour the third condition.

13. A parking meter (100, 200) according to any of the preceding claims,
characterized in
that the “predetermined time” of the third condition is one hour.

14. A parking meter (100, 200) according to any of the preceding claims,
characterized in
that it shows a layout (12) of the parking spaces (14, 15) assigned to this parking meter (100, 200), the actuating means (18) and indicating devices (20) being arranged and/or marked in the layout in such a way that an actuating means and an indicating device are unequivocally allocated to each parking space of the layout.

15. A parking meter (100, 200) according to claim 14,
characterized in
that a symbol, especially a numeral, is allocated to each parking space (14, 15) in the layout (12) on the parking meter (100, 200), whereby the same symbol, especially the same numeral, is allocated to each actuating means (18) and each indicating device (20) as well as to the corresponding parking space (14, 15).

16. A parking meter according to claim 7,
characterized in
that further luminescent diodes (42) are provided for indicating the early rundown of a chip card (28) and/or of the battery of the parking meter (200).
